(19) United States
(12) Patent Application Publication
(10) Pub. No.: US 2019/0329139 A1
(43) Pub. Date: Oct. 31, 2019

(54) Practical Application of a Virtual Coaching System and Method Within the Context of Multiplayer Video Games and Based Upon a Determined Playstyle of a Player

(71) Applicant: Activision Publishing, Inc., Santa Monica, CA (US)

(72) Inventors: Diego Di Giacomo Toledo, Los Angeles, CA (US); Gina L. Hope, Santa Monica, CA (US)

(21) Appl. No.: 16/395,113

(22) Filed: Apr. 25, 2019

Related U.S. Application Data
(60) Provisional application No. 62/663,022, filed on Apr. 26, 2018.

(51) Int. Cl. A63F 13/85; G06F 16/9535; G06F 16/9538; A63F 13/58; A63F 13/35; A63F 13/798; A63F 13/795

(52) U.S. Cl. CPC A63F 13/85; G06F 16/9535; G06F 16/9538; A63F 13/58; A63F 13/35; A63F 2300/558; A63F 13/795; A63F 2300/303; A63F 2300/556; A63F 2300/5566; A63F 13/798

(57) ABSTRACT

The present specification provides methods and systems for determining a player's playstyle based on a plurality of traits, extracted and determined from gaming parameters, and using the playstyle to present recommendations to a player via a virtual coaching system to help the player improve or modify the player's gaming skills for multiplayer video game play.

### CROSS-REFERENCE

The present specification relies on U.S. Patent Provisional Application No. 62/663,022, entitled “Virtual Coaching System and Method for Multiplayer Video Games”, and filed on Apr. 26, 2018, for priority, herein incorporated by reference in its entirety.

### FIELD

The present invention relates to methods and systems for determining a player's playstyle based on a plurality of traits, extracted and determined from gaming parameters, and using the playstyle to present recommendations to a player via a virtual coaching system to help the player improve or modify the player's gaming skills for multiplayer video game play.

### BACKGROUND

Multiplayer video games have exploded in popularity due, in part, to services such as Microsoft's Xbox LIVE® and Sony's PlayStation Network® which enable gamers all over the world to play with or against one another. Generally, a multiplayer video game is a video game in which two or more players play in a gameplay session in a cooperative or adversarial relationship. At least one of the players may comprise a human player, while one or more other players may comprise either non-player characters and/or other human players.

Conventionally, players improve their game with experience, which is gained over a period of time. Gaming skills are improved with practice and sometimes also by observing other players. Most gaming systems provide tutorials, which are useful to learn to play the game. However, the tutorials offer limited ability in training a player to help improve the game. The tutorials are also unavailable at the time of play, and are thus not provided to the payer in real-time. Moreover, the tutorials offer general guidance to play, for any player irrespective of whether the player is a beginner or is experienced. Some systems execute algorithms that generally compare the performance of a player with other players using high level statistics, such as number of points scored or kill/death ratios, but do not provide the player with specific advice as to how best to improve the player's performance.

Hence, there is need for automated systems and methods that aid players in improving and/or modifying their gaming skills using data generated by the players in the course of playing a video game. There is also need for automated systems and methods that analyze a player's performance and determine the player's style, tactics, weaknesses, and strengths in order to provide specific tactical and strategic tips for improving the player's performance.

### SUMMARY

The following embodiments and aspects thereof are described and illustrated in conjunction with systems, tools and methods, which are meant to be exemplary and illustrative, not limiting in scope.

While aspects of the invention may be described herein with reference to various game levels or modes, characters, roles, game items, etc. associated with a First-Person-Shooter (FPS) game, it should be appreciated that any such examples are for illustrative purposes only, and are not intended to be limiting. The training system and method described in detail herein may be used in any genre of multiplayer video game, without limitation.

The present specification discloses a computer implemented method of making recommendations to a player for improving gaming skills during a gameplay session, the method being implemented in a host computer having one or more physical processors programmed with computer program instructions that, when executed by the one or more physical processors, cause the host computer to perform the method, the method comprising: determining, by the host computer, the player's playstyle based on at least one player metric, wherein the player is associated with first performance data and wherein the first performance data comprises the at least one player metric; searching, by the host computer, for other players with similar playstyle, wherein the other players are associated with second performance data and wherein the second performance data comprises at least one average metric that is greater than the at least one player metric; comparing, by the host computer, the second performance data with the first performance data; determining, by the host computer, areas of improvement for the player based on the comparison; and presenting, by the host computer, recommendations to the player on the basis of the determined areas of improvement.

Optionally, the at least one average metric is greater than the at least one player metric by at least one standard deviation.

Optionally, determining the player's playstyle comprises determining values for game statistics of the player based on the first performance data. Optionally, values of the game statistics define one or more traits for a playstyle. Optionally, determining the player's playstyle comprises determining the values for game statistics based upon at least one of a map of the game or a mode of the gameplay.

Optionally, determining the player's playstyle comprises obtaining the player's self-identification of the playstyle.

Optionally, searching for the other players is based on at least a type of the game or a mode of the game.

Optionally, comparing the second performance data with the first performance data comprises comparing set of predefined game parameter values obtained from the first performance data with a corresponding set of predefined game parameter values obtained from the second performance data.

Optionally, determining of areas of improvement for the player is based on discrepancies between the second performance data and the first performance data.

Optionally, the method further comprises computer program instructions that, when executed by the one or more physical processors, cause the host computer to infer one or more generic recommendations from the one or more recommendations presented to the first player.

The present specification also discloses a system of making recommendations to a player for improving gaming skills during a gameplay session, the system comprising: a host computer comprising one or more physical processors programmed by computer program instructions that, when executed, cause the host computer to: determine the player's playstyle based on at least one player metric, wherein the player is associated with first performance data and wherein the first performance data comprises the at least one player metric; search for other players with similar playstyle, wherein the other players are associated with second performance data and wherein the second performance data comprises at least one average metric that is greater than the at least one player metric; compare the second performance data with the first performance data; determine areas of improvement for the player based on the comparison; and present recommendations to the player on the basis of the determined areas of improvement.

Optionally, the system further comprises a virtual coaching application hosted and implemented at least partly by the host computer. Optionally, the virtual coaching application comprises program instructions that, when executed, cause the host computer to processes one or more discrepancies between the second performance data and the first performance data and use the discrepancies to determine the areas of improvement for the player.

Optionally, the system further comprises a database in communication with the host computer for storing at least the first performance data and the second performance data.

Optionally, the system further comprises an audio output configured to present the recommendations to the player.

Optionally, the at least one average metric is greater than the at least one player metric by at least one standard deviation.

Optionally, the host computer comprises one or more physical processors programmed by computer program instructions that, when executed, cause the host computer to determine the player's playstyle by determining values for game statistics of the player based on the first performance data. Optionally, values of the game statistics define one or more traits for a playstyle. Optionally, the host computer comprises one or more physical processors programmed by computer program instructions that, when executed, cause the host computer to determine the player's playstyle by determining the values for game statistics based upon at least one of a map of the game or a mode of the gameplay.

Optionally, the host computer comprises one or more physical processors programmed by computer program instructions that, when executed, cause the host computer to determine the player's playstyle by obtaining the player's self-identification of the playstyle.

The present specification also discloses a computer implemented method of making recommendations to a player for improving gaming skills during a gameplay session, the method being implemented in a host computer having one or more physical processors programmed with computer program instructions that, when executed by the one or more physical processors, cause the host computer to perform the method. The method comprises: determining, by the host computer, the player's playstyle, wherein the player is associated with first performance data; searching, by the host computer, for other players with similar playstyle, wherein the other players have performance data superior to the first performance data; comparing, by the host computer, the performance data associated with the other players with the first performance data; determining, by the host computer, areas of improvement for the player based on said comparison; and presenting, by the host computer, recommendations to the player on the basis of the determined areas of improvement.

Optionally, determining the player's playstyle comprises determining game statistics of the player based on one or more gaming parameters. Optionally, the one or more gaming parameters define one or more traits that comprise a playstyle. Optionally, determining the player's playstyle comprises determining a context of the game or obtaining the player's self-identification of the playstyle.

Optionally, searching for the other players is based on at least a type of the game or a context of the game. Optionally, comparing the performance data associated with the other players with the first performance data comprises comparing set of predefined statistics obtained from the first performance data with corresponding statistics obtained from the performance data associated with the other players. Optionally, the determining of areas of improvement for the player is based on discrepancies between the performance data associated with the other players and the first performance data.

Optionally, the computer implemented method of making recommendations to a player for improving gaming skills during a gameplay session further comprises computer program instructions that, when executed by the one or more physical processors, cause the host computer to infer one or more generic recommendations from the one or more recommendations presented to the first player.

The present specification also discloses a system of making recommendations to a player for improving gaming skills during a gameplay session. The system comprises: a host computer comprising one or more physical processors programmed by computer program instructions that, when executed, cause the host computer to: determine the player's playstyle, wherein the player is associated with first performance data; search for other players with similar playstyle, wherein the other players have performance data superior to the first performance data; compare the performance data associated with the other players with the first performance data; determine areas of improvement for the player based on said comparison; and present recommendations to the player on the basis of the determined areas of improvement.

Optionally, the host computer is configured as one of a gaming console, a handheld gaming device, a personal computer, a smartphone, a tablet computing device, a smart television, and a device usable for interaction with an instance of a video game.

Optionally, the system further comprises a virtual coaching application hosted and implemented at least partly by the host computer.

Optionally, the virtual coaching application comprises program instructions that, when executed, cause the host computer to processes one or more discrepancies between the performance data associated with the other players and the first performance data, the discrepancies being used to determine the areas of improvement for the player. Optionally, the system further comprises a virtual coaching application implemented on a server computer in communication with the host computer and one or more other host computers.

Optionally, the system further comprises a database in communication with the host computer for storing at least the first performance data and the performance data of the other players; and one or more peripheral devices for at least presenting the recommendations to the player.

Optionally, the recommendations are presented to the player through an audio mechanism configured within the host computer; and the player's playstyle is determined by determining game statistics of the player based on one or more gaming parameters, or by determining a context of the game. Optionally, the search for the other players is based on at least a type of the game or a context of the game.

The aforementioned and other embodiments of the present specification shall be described in greater depth in the drawings and detailed description provided below.

### BRIEF DESCRIPTION OF THE DRAWINGS

These and other features and advantages of the present specification will be appreciated, as they become better understood by reference to the following detailed description when considered in connection with the accompanying drawings, wherein:

FIG. 1 illustrates an exemplary system environment for providing virtual coaching to a player of multiplayer video games, according to an implementation of the present specification.

FIG. 2 is a flowchart depicting a process for providing virtual coaching to a player of multiplayer video games, according to an implementation of the present specification;

FIG. 3 is a flowchart illustrating the steps of determining a player's playstyle, in accordance with an embodiment of the present specification;

FIG. 4 is a flowchart illustrating the steps of determining the areas where a specific player may need to improve, in accordance with an embodiment of the present specification; and

FIG. 5 illustrates an exemplary interface providing recommendations for improvement in one or more areas of a specific game, in response to a request by a player, in accordance with an embodiment of the present specification.

### DETAILED DESCRIPTION

In embodiments, the present specification relates to methods and systems for determining a player's playstyle using a plurality of traits, extracted and determined from gaming parameters, and presenting recommendations to a player via a virtual coaching system to help the player improve or modify the player's gaming skills in multiplayer video games.

In embodiments, the present specification relates to a virtual coaching system and method that aids a player of multiplayer video games to improve the player's gaming skills during a gaming session.

The present specification is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

In the description and claims of the application, each of the words “comprise” “include” and “have”, and forms thereof, are not necessarily limited to members in a list with which the words may be associated. It should be noted herein that any feature or component described in association with a specific embodiment may be used and implemented with any other embodiment unless clearly indicated otherwise.

It should be appreciated that the programmatic methods described herein may be performed on any computing device, including a laptop, desktop, smartphone, tablet computer, specialized gaming console, or virtual reality system. The computing device comprises at least one processor and a nonvolatile memory that stores the programmatic instructions which, when executed by the processor, perform the methods or steps disclosed herein, including the generation of a graphical user interface that is communicated to a local or remote display. The computing device is in communication with at least one remotely located server through a network of any type.

For purposes of the present specification, a gaming console is a computing device that displays a video game that one or more players can play.

While aspects of the present specification may be described herein with reference to various game levels or modes, characters, roles, or game items, associated with a First-Person-Shooter (FPS) game, it should be appreciated that any such examples are for illustrative purposes only, and are not intended to be limiting. The systems and methods described in detail herein may be used in any genre of multiplayer video game, without limitation.

The terminology used within this specification and detailed description of the various embodiments is for the purpose of describing particular embodiments only and is not intended to limit the invention.

The claimed inventions herein represent a practical application of analyzing videogame data to generate a specific categorization of a player, identify corresponding other players, and generate and present areas of improvement based on other player data in a manner that is tailored to a multiplayer videogame environment. In a preferred embodiment, videogame session data, comprising player gaming parameters or statistics, is transmitted to a host server that is configured to receive such session data from multiple players, each operating a client device, substantially concurrently. The server is geographically remote from the client device(s). In one embodiment, the server is configured to receive such individualized player gaming parameters or statistics from at least 10 client devices substantially concurrently. Preferably, the server is configured to receive such individualized player gaming parameters or statistics from at least 10 to at least 1,000,000 client devices, or any numerical increment therein, substantially concurrently.

For each set of individualized player gaming parameters or statistics received, the server is further configured to determine each player's playstyle, wherein the player is associated with first performance data based on at least one player metric, search for other players with a similar playstyle, wherein the other players have performance data equal or superior to the first performance data, compare the performance data associated with the other players with the first performance data, determine areas of improvement for each player based on the comparison, and present recommendations to each player on the basis of the determined areas of improvement. Again, the server is geographically remote from each of the players operating their client device(s) and is configured to perform each of the above described steps from at least 10 client devices substantially concurrently or, more preferably, from at least 10 to at least 1,000,000 client devices, or any numerical increment therein, substantially concurrently.

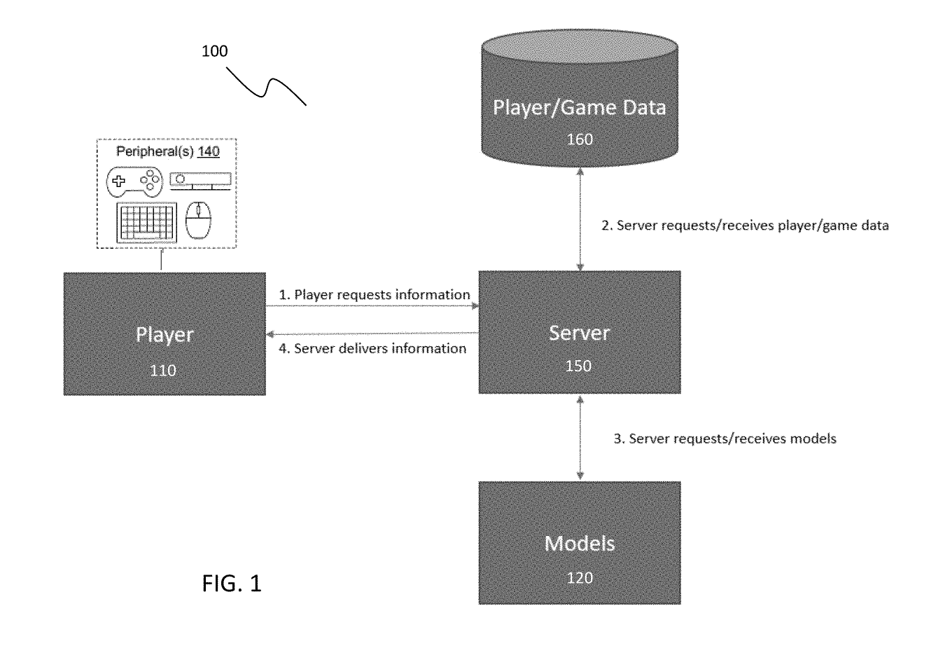

FIG. 1 illustrates an exemplary system environment 100 for providing recommendations, via a virtual coach, for a player of a multiplayer video game, in accordance with some embodiments of the present specification. A given computer system 110 functions as a host computer that hosts gameplay between (or with) other devices, such as other computer system(s) similar to computer system 110. In one implementation, a server 150 is configured to store and execute a virtual coaching assistant application that is periodically receiving or receives data from a computer system 110 regarding a player's performance in one or more video game sessions. Data and/or other information described herein, and server 150 accesses such data, as needed, from the database 160. Thus, in one implementation, the outputs described herein may be determined by a virtual coaching application hosted and implemented in part or whole by the computer system 110 and/or by the server 150.

In another implementation, server 150 represents multiple servers, configured in a serial, parallel, or cloud architecture distributed across one or more printed circuit boards, where a first server of the multiple servers 150 is configured to host and support a conventional videogame session among multiple players and to periodically receive data from a computer system 110 regarding players' performance in one or more video game sessions. The first server of the multiple servers 150 transmits player data to database 160 for storage. Another server of the multiple servers 150 is configured to store and execute a virtual coaching assistant application and receive player data from the first server of the multiple servers 150 or from the database 160. Thus, in this implementation, the outputs described herein may be determined by a virtual coaching application hosted and implemented in part or whole by a portion of the multiple servers 150 in data communication with the computer system 110.

System environment 100 facilitates communication between various systems and components in order to provide recommendations to the player at computer system 110, and additionally to other players, as and when requested by them. In some instances, the recommendations provided by the implementations of the present specification may support the player with information that could improve the player's gaming skills. Therefore, embodiments of the present specification may result in enhanced performance by the player, leading to more positive gameplay outcomes for the player. For purposes of description, the term ‘player’ here may also be sometimes referred to as the ‘first player’, in order to distinguish from other players.

In one implementation, system environment 100 may include one or more computer systems 110, one or more servers 150, and one or more databases 160, and/or other components. Additionally, environment 100 comprises a recommendation application or module 120.

Computer system 110 may be configured as a gaming console, a handheld gaming device, a personal computer (e.g., a desktop computer, a laptop computer, etc.), a smartphone, a tablet computing device, a smart television, and/or other device that can be used to interact with an instance of a video game. In embodiments, computer system 110 is controlled by the player engaging with a gaming system implemented through the gaming console. Computer system 110 may include one or more processors, one or more storage devices (which may or may not store application or module 120), one or more peripherals, and/or other components. The processors may be programmed by one or more computer program instructions. For example, the processors may be programmed by module or application 120 and/or other instructions (such as gaming instructions used to instantiate the game).

The various instructions described herein may be stored in a storage device which may comprise random access memory (RAM), read only memory (ROM), and/or other memory. The storage device may store the computer program instructions (e.g., the aforementioned instructions) to be executed by the processor as well as data that may be manipulated by the processor. The storage device may comprise floppy disks, hard disks, optical disks, tapes, or other storage media for storing computer-executable instructions and/or data.

The various components illustrated in FIG. 1 may be coupled to at least one other component via a network, which may include any one or more of, for instance, the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network. In FIG. 1, as well as in other Figures included herein, different numbers of entities than those depicted may be used. Furthermore, according to various implementations, the components described herein may be implemented in hardware and/or software that configure hardware.

The various database 160 described herein may be, include, or interface to, for example, an Oracle™ relational database sold commercially by Oracle Corporation. Other databases, such as Informix™, DB2 (Database 2) or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The database may store a plurality of types of data and/or files and associated data or file descriptions, administrative information, or any other data.

In some instances, a given server 150 may be associated with a proprietary gameplay network system, such as, without limitation, SONY PLAYSTATION NETWORK, MICROSOFT XBOX LIVE, and/or another type of gameplay network system. In this implementation, a given computer system 110 may be associated with a particular type of gaming console. Other types of computer systems 110 using other types of gameplay networks may be used as well. Server 150 may include one or more physical processors (also interchangeably referred to herein as processors, processor(s), or processor for convenience) programmed by computer program instructions, one or more storage devices (which may store module or application 120), and/or other components. The processors may be programmed by one or more computer program instructions. For example, the processors may be programmed by gaming instructions used to instantiate the game.

In one implementation, a player at computer system 110 prompts server 150 for information. The information may be in the form of recommendations that enable the player to improve gaming skills. The player may request or ask for recommendations or advice during, after, and/or between game play sessions. In some embodiments, the player requests information related to their performance, such as for example, how their performance can be improved. The player may ask for recommendations or request information either verbally or through one or more options provided by means of a graphical user interface, by the gaming system. For example, the player may prompt the system by:
Speaking to the computer system 110 and verbalizing a specific request, such as “How did I do in the last match?”, “How do I improve my skills?”, “What strategy should I use?”, “What role should I play?”. “What division should I use?”, or “Why did I lose?”, among other questions. In such a case, the computer system 110 comprises a microphone, or is in data communication with a voice assistant peripheral, that receives the verbalized request and communicates the verbalized request to a processor which translates the verbalized request into a parsed data stream, and processes the parsed data stream to determine the nature of the request. Alternatively, the computer system communicates the parsed data stream to the server 150, in the form of an interface call, which, in turn, processes the parsed data stream to determine the nature of the request.
Prompting the computer system 110 to visually display a series of predefined informational requests, such as “How did I do in the last match?”, “How do I improve my skills?”, “What strategy should I use?”, “What role should I play?”. “What division should I use?”, or “Why did I lose?”, among other questions. In such a case, the player selects one of the informational requests through an input device, such as a game controller, keyboard, mobile phone, touch screen, mouse, trackpad, wireless device, or other device. A processor receives the selection and processes the selection stream to determine the nature of the request. Alternatively, the computer system 110 communicates the selection to the server 150, in the form of an interface call, which, in turn, processes the parsed data stream to determine the nature of the request.
Typing into a graphical user interface, generated by the computer system 110, a freeform information request, such as “How did I do in the last match?”, “How do I improve my skills?”, “What strategy should I use?”, “What role should I play?”. “What division should I use?”, or “Why did I lose?”, among other questions. In such a case, the player inputs the informational requests through an input device, such as a game controller, touch screen, mouse, keyboard, mobile phone, trackpad, wireless device, or other device. A processor receives the freeform informational request, translates the request into a parsed data stream, and processes the parsed data stream to determine the nature of the request. Alternatively, the computer system communicates the parsed data stream to the server 150, in the form of an interface call, which, in turn, processes the parsed data stream to determine the nature of the request.

Prior to, or concurrent with, receiving the informational request, the server 150 has been periodically receiving, or receives, data from the computer system 110 regarding the player's performance in one or more video game sessions. The server 150 may receive player performance data regarding the player's level in the video game, number of kills, frequency of deaths, points scored, treasure obtained, geographical location in a virtual world corresponding to a level in the video game, materials used, weapons used, frequency of game play, player speed, player movement, player success at specific challenges, player reaction to specific challenges, causes of player death, player selected teams, divisions, or other groupings, among other data (collectively, “Player Performance Data”). Preferably, when received by the computer system, the Player Performance Data is first stored in database 160 in the form of cells, rows, and columns in one or more table formats. Database 160 may store data related to game profiles, player profiles, playstyle of other gamers, Player Performance Data and/or other information described herein, and server 150 accesses such data, as needed, from the database 160.

The server 150 processes one or more portions of the Player Performance Data in order to derive numerous outputs related to the player's playstyle, what causes the player to die, what are the player's weaknesses, what are the player's strengths, the overall performance of the player, changes in play strategy or tactics that could result in improving the player's performance, among other outputs.

In an embodiment, when a videogame session terminates, the client software generates an end of match data package comprising various types of information, ranging from metadata, such as ping rate and time of match, to a player's personal statistics, such as, for a first person shooter game, total kills, total distance travelled, number of shots hit, and number of shots missed. The end of match data package is sent by the client to the server 150. In embodiments, the server 150 receives the end of match data package, specific to a particular player and terminated videogame session, and applies a correlation process to the end of match data package to analyze the data and extract and store specific player statistics. In one embodiment, the server 150 executes a correlation process that 1), for a given videogame, identifies each available combination of map and game mode, wherein the map provides a visual delineation of the virtual geography of the videogame for a given mode of play, 2) for each available combination of map and game mode, all available end of match data package statistics are examined, 3) those end of match data package statistics which are strongly correlated, either in a positive or negative way, with a higher scoring rate (i.e. score per minute) are identified and 4) those identified statistics are stored in database 160. In one embodiment, a strong correlation is determined if the probability of a magnitude of a value of a statistic being above or below a threshold value, based upon the value of a corresponding scoring rate, exceeds a predefined probability threshold.

For example, for a first person shooter game, statistics such as, but not limited to, weapon kills, headshots, grenade kills, accuracy, and deaths tend to be strongly correlated, either positively or negatively, with the player's scoring rate and are therefore stored. Personal statistics such as, but not limited to, knife kills, unmanned aerial vehicle (UAV) or drone kills, and mine kills tend to not be strongly correlated, either positively or negatively, with the player's scoring rate and are therefore not stored.

It should be appreciated that the outputs described herein may be determined by a virtual coaching application hosted and implemented in part or whole by the computer system 110 and/or by the server 150. The processing described herein may be performed automatically by the virtual coaching application, which can continuously review new data generated and collected by the computer system 110 during and after gameplay.

In one embodiment, the server 150 and/or computer system 110, via the virtual coaching application, determines a player's playstyle from the Player Performance Data and provides it to the player in response to the request received from computer system 110. It should be appreciated the term “playstyle” comprises a combination of player traits which are indicative of certain behaviors, such as, but not limited to, how the player prefers to engage opposing players or how the player prefers to move in the game, and where each of the individual traits are determined from gaming parameters that quantify the player's performance in the game, such as, but not limited to, kill/death ratio, average kill distance, loadout/weapons/armor used, distance travelled, average speed, linearity of movement, or use of crouch, jump, or strafe.

In an embodiment, the server determines a player's set of traits, and therefore playstyle, on the basis of one or more gaming parameters that are associated with that player. The one or more gaming parameters may be used to identify one or more traits that indicate the playstyle. In an example, a player trait of how the player engages in combat is partially indicative of a playstyle and may be identified using multiple gaming parameters such as, and not limited to, kill/death ratio, average kill distance, loadout/weapons/armor used, self-identification, or any other data. Similarly, another exemplary player trait partially indicating playstyle is how player moves during a game, which may be identified using multiple gaming parameters such as, and not limited to, distance travelled, average speed, linearity of movement, use of crouch, jump, or strafe, among others. In embodiments, the one or more traits that indicate a playstyle are combined to determine the overall playstyle of the player.

In embodiments, a player's playstyle is determined by a query from a database of the server 150. For example, in an embodiment, the server 150 queries the average kill distance, total distance travelled, and average speed of a player in a first person shooter game to determine that player's playstyle. In an embodiment, a record representing the player's playstyle may be: avg_k_dist, total_dist_travelled, avg_speed—10, 23589, 456, and can be represented in any data structure format, such as an alphanumeric string or XML file.

In yet other embodiments, a playstyle may be specific to a context, where the context may be according to the game, the mode, the game level, the game map, or any other. For example, a different playstyle may be assigned for different games. Sports games may have a different playstyle from vehicle-simulation games, which may be still different from strategy games, and so on. Additionally, different playstyles may be assigned within a specific game, with different gaming modes and levels.

In another embodiment, a player's self-identification may be used to determine the playstyle. For example, a player may indicate, in their profile, that s/he is a sniper player, as opposed to a run and gunner or camper.

Once a request is received from computer system 110, server 150 and/or computer system 110 seeks data from a database 160. Database 160 responds to the request made by server 150 by providing information about other players (gamers) with a playstyle similar to that of the player at computer system 110. Server 150 and/or computer system 110 determines the best players with similar playstyle and further provides this information to virtual coaching application, also known as recommendation application, 120 for comparison and processing. The best players may be determined by referencing certain game statistics that are indicative of the player's performance, such as kill/death ratios, points scored, tokens earned, ranking, or other Player Performance Data, and comparing such data for all players to determine a set of players that are better than the player requesting improvement advice. In an embodiment, an exemplary

Recommendation module or application 120 compares the playstyle of the player at computer system 110, with other players with similar playstyle, determined by server 150 and/or computer system 110. Application 120 processes the discrepancies between the data to identify areas where the player could improve, in order to remove these discrepancies. The identified areas are communicated to server 150 and/or computer system 110, which translates them into player recommendations. The recommendations are sent to the player through computer system 110 or any other peripheral device 140, as information in response to a request from the player. The recommendations may be verbally announced through an audio mechanism configured within computer system 110, or a peripheral device 140. Alternatively, the recommendations may be displayed through the gaming interface provided by computer system 110.

Depending on the system configuration, recommendation module or application 120 (or portions thereof) may be part of a game application, which creates a game instance to facilitate gameplay. In embodiments, portions of or all of module or application 120 may run on computer system 110 or server 150.

In an embodiment, recommendation module or application 120 is a virtual coaching application, comprising a plurality of programmatic instructions, that is hosted by a separate computer system that is in data communication with computer system 110 and/or server 150. The instructions may include, without limitation, comparing the player with player(s) that have a playstyle similar to the player, determining improvements based on the discrepancies identified in the playstyles, and present recommendations to the player so that the discrepancies are reduced/removed/minimized, thereby improving the player's gaming skills. As used herein, for convenience, the various instructions will be described as performing an operation, when, in fact, the various instructions are executed by the processors, in computer system 110 or server 150, to perform the operation.

Alternatively or additionally, recommendation module or application 120 may run on a device such as server 150 to compare users and determine custom recommendations for each player in an “online” game hosted by server 150. Thus, in another embodiment, application or module 120 may include programmatic instructions implemented on program server 150. The instructions may include, without limitation, instructions for comparing the player with the best player(s) that have a playstyle similar to the player, determining improvements based on the discrepancies identified in the playstyles, presenting recommendations to the player so that the discrepancies are reduced/removed/minimized, thereby improving the player's gaming skills, and/or other instructions that program server 150 to perform various operations, each of which are described in greater detail herein. As used herein, for convenience, the various instructions will be described as performing an operation, when, in fact, the various instructions program the processors (and therefore server 150) to perform the operation.

Peripherals 140 may be used to obtain an input (e.g., direct input, measured input, etc.) from a player, as previously described in relation to receiving a player's input or selection. In embodiments, the player posts a request related to improving their gaming skills, as the input. Peripherals 140 may include, without limitation, a game controller, a gamepad, a keyboard, a mouse, an imaging device such as a camera, a motion sensing device, a light sensor, a biometric sensor, and/or other peripheral devices that can obtain an input from and/or relating to a player. Peripherals 140 may be coupled to a corresponding computer system 110 via a wired and/or wireless connection. In some embodiments, peripherals 140 include an audio system, such as a speaker, that receives verbal requests from the player and provides responses to the request in the form of an audio output. A voice assistant may be configured to interact with the player to receive information requests and provide recommendations. The voice assistant may be in communication with server 150 and/or computer system 110 over a wired or a wireless network.

Although illustrated in FIG. 1 as a single component, computer system 110 and server 150 may each include a plurality of individual components (e.g., computer devices) each programmed with at least some of the functions described herein. In this manner, some components of computer system 110 and/or server 150 may perform some functions while other components may perform other functions, as would be appreciated. The one or more processors may each include one or more physical processors that are programmed by computer program instructions. Thus, either or both server 150 and computer system 110 may function as a host computer programmed by application 120. The various instructions described herein are exemplary only. Other configurations and numbers of instructions may be used, so long as the processor(s) are programmed to perform the functions described herein.

The description of the functionality provided by the different instructions described herein is for illustrative purposes, and is not intended to be limiting, as any of instructions may provide more or less functionality than is described. For example, one or more of the instructions may be eliminated, and some or all of its functionality may be provided by other ones of the instructions. As another example, processor(s) may be programmed by one or more additional instructions that may perform some or all of the functionality attributed herein to one of the instructions.

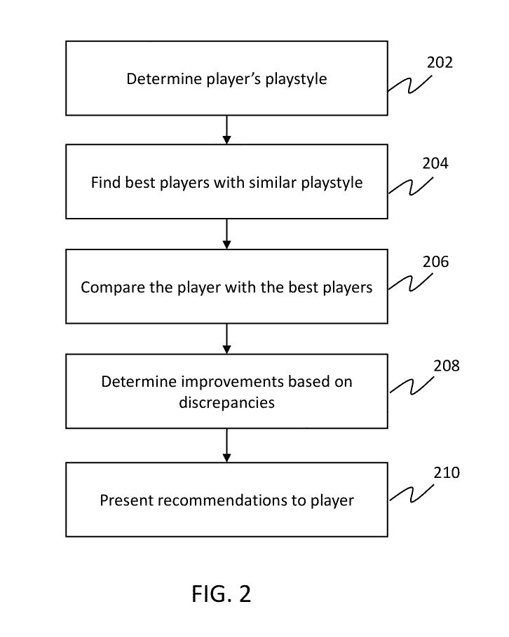

FIG. 2 illustrates an exemplary process for providing recommendations for a player of a video game, in accordance with some embodiments of the present specification. The described operations may be accomplished using some or all of the system components described in detail above and, in some implementations, various operations may be performed in different sequences and various operations may be omitted. Additional operations may be performed along with some or all of the operations shown in the depicted flow diagram. One or more operations may be performed simultaneously. Accordingly, the operations as illustrated (and described in greater detail below) are exemplary by nature and, as such, should not be viewed as limiting.

According to an aspect of the invention, at 202, the player's playstyle is determined. In an implementation of a first-person-shooter (FPS) game, playstyle of a player may be determined on the basis of one or more gaming parameters determined for that player. The one or more gaming parameters may be used to identify one or more traits that comprise the playstyle. In an example, a player trait of how player engages in combat is partially indicative of a playstyle, and may be identified using multiple gaming parameters such as, and not limited to, kill/death ratio, average kill distance, loadout/weapons/armor used, self-identification, any other. Similarly, another exemplary trait partially indicating playstyle is how player moves during a game, which may be identified using multiple gaming parameters such as, and not limited to, distance travelled, average speed, linearity of movement, use of crouch/jump/strafe, among others. The one or more player traits that indicate a playstyle are combined to determine the overall playstyle of the player. The playstyle can be determined by the embodiments of the present specification by examining various traits that combine the various gaming parameters or statistics. Additionally, the player's self-identification may be used to determine the playstyle. For example, the player indicates in the corresponding profile that s/he is a sniper player.

In some embodiments, the playstyles are specific to a context, where the context may be according to the game, the mode, the game level, the game map, or any other. For example, different playstyle may be assigned for different games. Sports games may have a different playstyle from vehicle-simulation games, which may be still different from strategy games, and so on. Additionally, different playstyles may be assigned to a specific game. For example, playstyles may vary within a game, with different gaming modes and levels.

In some embodiments, the playstyle is determined by a virtual coaching application hosted and implemented in part or whole by a computer system that provides the gaming platform and interface for the player. The playstyle analysis may be performed automatically by the application, which can continuously review new data gathered from the game. In one implementation, the application processes the player's most recent game data to update the player's evolving playstyle. The data collected from multiple games played by the player may be weighted in one or more ways based on player metrics, as described further below. For example, data collected from a more recent game may be weighted more than the data from previous games.

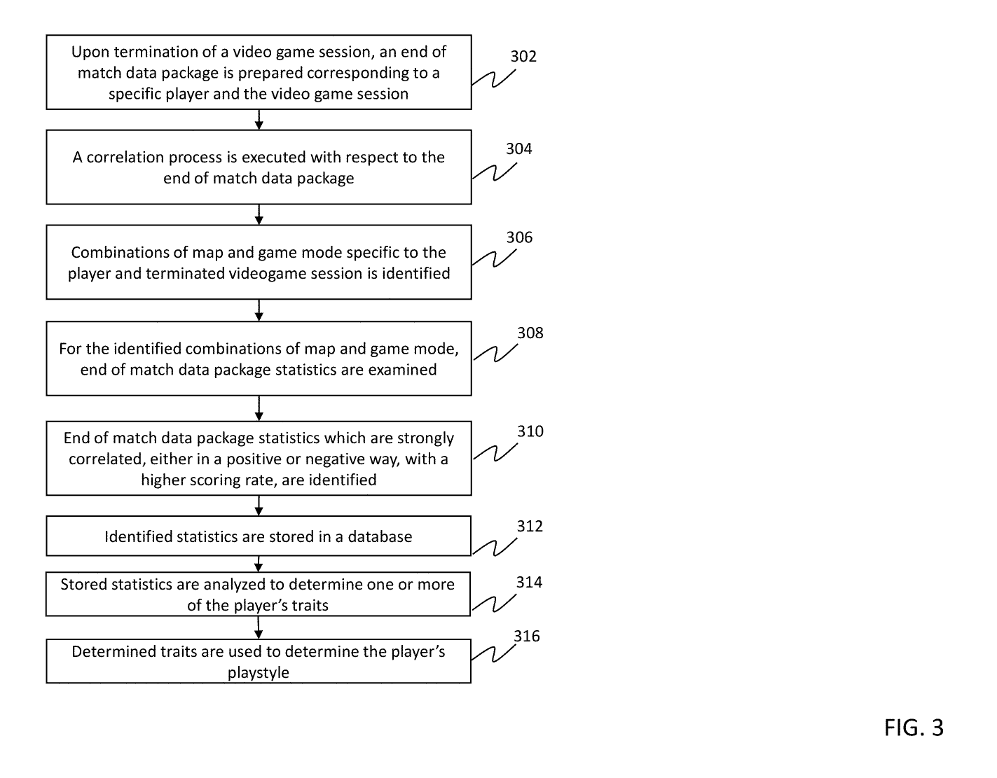

FIG. 3 is a flowchart illustrating the steps of determining a player's playstyle, in accordance with an embodiment of the present specification. At step 302, upon termination of a video game session, an end of match data package is prepared corresponding to a specific player and the video game session. In various embodiments, the data package comprises various types of information, ranging from metadata, such as ping rate and time of match, to the player's personal statistics, such as, for a first person shooter game, total kills, total distance travelled, number of shots hit, and number of shots missed. In an embodiment, the data package is prepared by client software and sent to a server computer.

At step 304, a correlation process is executed with respect to the end of match data package, specific to the particular player and terminated videogame session, to analyze the data and extract and store specific player statistics. At step 306 the correlation process identifies each available combination of map and game mode specific to the particular player and terminated videogame session. In embodiments, the map provides a visual delineation of the virtual geography of the videogame for a given mode of play.

At step 308 the correlation process examines, for each of the identified combination of map and game mode, available end of match data package statistics. At step 310 the correlation process identifies the end of match data package statistics which are strongly correlated, either in a positive or negative way, with a higher scoring rate (i.e. score per minute).

At step 312 the identified statistics corresponding to the specific player are stored in a database. In one embodiment, a strong correlation is determined if the probability of a magnitude of a value of a statistic being above or below a threshold value, based upon the value of a corresponding scoring rate, exceeds a predefined probability threshold. For example, for a first person shooter game, statistics such as, but not limited to, weapon kills, headshots, grenade kills, accuracy, and deaths are stored with respect to a player as these tend to be strongly correlated, either positively or negatively, with the player's scoring rate.

At step 314, the stored statistics are analyzed to determine one or more of the player's traits. At step 316 the determined traits are combined to determine the player's playstyle. In embodiments, a player trait of how the player engages in combat is partially indicative of a playstyle and may be identified using multiple gaming statistics of the player, such as, and not limited to, kill/death ratio, average kill distance, loadout/weapons/armor used, self-identification, or any other data.

Referring back to FIG. 2, at 204, best players with a similar playstyle are determined. Other players with the playstyle determined at 202 are identified from a database. The playstyle determined at 202, is used to find other players. As discussed above, the playstyle may be based on a combination of traits or self-identification by the player. The basis for determining a playstyle may be used as a classification. Other players with similar playstyles may then be recognized under the same classification. In one example, a classification may be based on ‘sniper’ self-identification. Thus other players identified as ‘sniper’ are considered to have a similar playstyle. Embodiments of the present specification seek the best players with the same classification of the playstyle, as the first player. In some embodiments, playstyles are evaluated and defined by metrics associated with a game type, for example, an FPS, and include, but are not limited to, average kills distance (defined as the average distance from a first player to a second player killed by the first player when the kill occurs), total distance travelled, average speed, kill-to-death ratio, score-per-minute, and player level. In another embodiment, the best players are sought that exhibit a similar playstyle as the first player. For example, the best players are searched who exhibit engagement and movement patterns (playstyle based on one or more traits) within some similarity threshold.

The best players are identified based on one or more factors, which may vary based on a type of game or the context of the game. In an example of a FPS game, players with a high kill-to-death ratio, high score-per-minute, high level, or any other factor indicative of skill or performance may be identified as best players. In one embodiment, a specific percentage of the players with the highest performance are identified as the best players. In some embodiments, the player traits for identifying the best players is weighted depending on the game or the context of the game. For example, the player traits, or underlying player gaming parameters, may be weighted on the basis of total wins, total kills, win to loss ratio, kill-to-death ratio, experience, and level. In some embodiments, the best player(s) is determined by calculating averages and standard deviations of a particular metric among a certain number of players in one or more matches and identifying players scoring at least one standard deviation above the average as the best player(s). For example, in some embodiments, the averages and standard deviations are calculated from the metrics of players from 500 matches. Those players scoring at least one standard deviation above the average for a metric are considered the best players.

At 206, the first player is compared with the best players of similar playstyle, which were identified at 204. For a particular playstyle and/or context, embodiments of the present specification define the most important traits and/or statistics for success. These are the statistics that correlate most closely with a player being among best players. The statistics and/or traits to identify the best players may be combed through a machine learning algorithm, through human intervention, or through a combination of both. The machine can mine large and evolving datasets to derive and learn patterns to continuously improve its understanding of which statistics correlate highly with besting a best player. Programmers (humans) can manually define the statistics to compare.

In the FPS example, if the best players are defined as players with the highest “score per minute,” then the statistics that correlate most closely with a high score per minute are determined. The statistics that correlate with the high score per minute may include, number of kills, number of deaths, number of headshots, number of hits, number of shots, or any other. In embodiments, the statistics that are determined are for the specific playstyle that was identified at 202. In one embodiment, the machine generates all polynomial combinations to a particular degree to find better correlations. In one embodiment, the machine generates all polynomial combinations to a second degree to find better correlations. Over a large data set, the machine can learn that some of these individual statistics or polynomial combinations will not have statistical relevance, and can be ignored, and others will highly correlate with best players. The result is the machine will have various models for different games/levels/modes/contexts of what statistics/traits are important to being successful within each playstyle. For example, for a “sniper” playstyle, it may be determined that shooting accuracy is a statistic that best correlates with overall player success. For a “run and gunner” playstyle, it may be determined that movement speed combined with total number of kills is a statistic that best correlates with overall player success. Accordingly, the correlation process identifies a subset of gaming parameters or statistics (of a larger total number of gaming parameters or statistics) that most strongly correlates with overall player success in a game.

Embodiments of the present specification compare each statistic and/or trait, or a subset thereof, of the first player with that of the best players. Preferably, the statistics/traits that are compared are the ones that, through the correlation process, have been determined to be important to being successful for the playstyle of the player. In an example, if kill to death ratio and headshots correlate most closely with being a best player for that playstyle, the player's performance for those particular gaming parameters or statistics is compared to the best players' performances in those areas with similar playstyle. The comparison yields discrepancies between the performances of the first player and the other best players. One or more statistics/traits that exhibit discrepancies greater than a threshold specified for that statistic/trait, are identified as areas where the first player may need to improve. In some embodiments, the threshold is determined by calculating averages and standard deviations of a particular metric among a certain number of players in one or more matches, as described further below. For example, in some embodiments, the threshold is at least one or more standard deviations below an average calculated from metrics of high performance players from 500 matches. Several methods may be used to configure the threshold for each statistic/trait and perform the comparison. In one embodiment, the comparison is performed by checking whether the first player's statistic is within a predefined threshold of a weighted mean value of the statistics of the best players. In another embodiment, the variance of a particular statistic is taken into consideration, either in addition to or in place of, the weighted mean. In this embodiment, it is determined whether the first player falls outside of that variance window to infer whether the first player needs to improve that statistics.

In an exemplary embodiment, the server has determined a first player's playstyle and is now determining areas of improvement for that first player. To do so, the server accesses a database of stored playstyles and Player Performance Data to identify a set of other players having a) a similar playstyle to the first player and b) a performance that exceeds a threshold value. The performance may in terms of total score or a scoring rate. Therefore, in one embodiment, the server accesses a database to identify players who have a similar playstyle to the first player and who have a scoring rate (i.e. number of points or kills per rate of time, such as a minute) that exceeds a predefined threshold value. A predefined number of such players are identified and their corresponding data are obtained.

For example, N matches of such high performance players may be fetched (where N is a number from 200 to 1000, preferably 500, and fetch is defined as getting, reading, or moving data) from a database using a K-Nearest Neighbors algorithm or any other pattern recognition or non-parametric method of classification and/or regression. In some embodiments, the metrics used for the fetch include: average kills distance, total distance travelled, and average speed. From these N matches, an average and a standard deviation for each of the metrics is calculated to create a list of averages and standard deviations. Each of the corresponding first player's metrics is compared against the generated average and standard deviation list for a specific metric. The server identifies first player metrics where the metric is above, such as at least 1 standard deviation above, the corresponding average metric for the high-performance players. The server identifies this metric (where the first player's value is a standard deviation above the other players' average) as a highlight.

The server further identifies first player metrics where the metric is below, such as 1 standard deviation below, the average of the high performance players' corresponding metric. In an embodiment, the server identifies certain metrics of the first player, which has a lower value relative to the corresponding metric of the high performance players, as being an area, gaming parameter, statistics or skill requiring improvement.

Since players may have changing playstyles, or changing metrics underlying the playstyles, the list of N matches may be different for every fetch, and consequently, the averages and standard deviations may be constantly changing. Therefore, in certain embodiments, depending on the playstyles of the players in a N match fetch, different metrics will be considered highlights and different players will receive recommendations for the incident fetch relative to other fetches, based on the averages and standard deviations calculated from the metric data associated with the fetch. At 208, improvements for the player are determined based on the discrepancies between the first player and the best players. Embodiments of the present specification determine the most suitable recommendation for the first player on the basis of each discrepancy identified at 206. The recommendations may be configured through various methods including manually curated lists by humans and/or through machine learning. In one example, if at 206, a need was identified for the first player to improve their statistic pertaining deaths per game, the programmers of the system in accordance with embodiments of the present specification manually create recommendations for reducing deaths. Alternatively or additionally, in this example, the system automatically analyzes game data to determine recommendations for reducing deaths. In one instance, the system may analyze that players with more armor die less, therefore it recommends to the first player to equip with more and/or better armor. In another instance, the system reviews heatmaps of where the first player dies on a particular map and notifies the first player that he dies a lot in an area ‘x’, and recommends to avoid the area ‘x’, where ‘x’ is the area where the first player dies or dies more frequently.

The system may also infer a generic recommendation from the one or more recommendations provided to the first player. As noted above, if a metric for a player falls at least one standard deviation below an average for the metric calculated over a predetermined number of matches, this player will be considered low scoring and will receive a recommendation to improve in relation to this metric. If the player dies too much within the game, and the system records that that the recommendation had a perk to be more resistant to grenades, the system infers that the recommendation is trying to make the player's character in the game die less by using this perk. The inferences may also by derived directly by the first player. In another example, most first players with low accuracy will get some weapon attachment to improve weapon handling. While recognizing the areas of improvement for the first player, the system correlates ‘pairs’ of information to derive a generic recommendation.

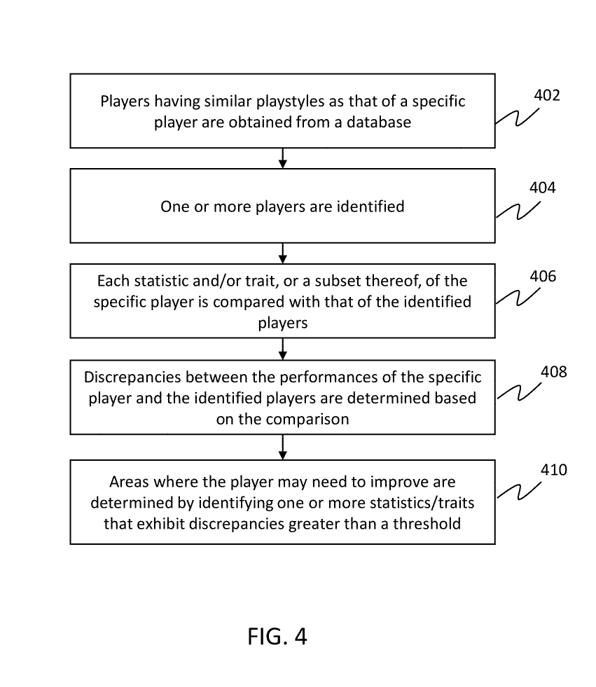

FIG. 4 is a flowchart illustrating the steps of determining the areas where a specific player may need to improve, in accordance with an embodiment of the present specification. At step 402, a plurality of players having similar playstyles as that of a specific player are obtained from a database. At step 404, one or more best players from among said plurality of players are identified. In an embodiment, a best player is defined as a player having a similar playstyle as the specific player and having scored data exceeding a threshold value. At step 406, each statistic and/or trait, or a subset thereof, of the specific player is compared with that of the best players. In embodiments, the statistics/traits that are compared are the ones that, through the correlation process, have been determined to be important to being successful for the playstyle of the player. In an example, if kill to death ratio and headshots correlate most closely with being a best player for that playstyle, the player's performance for those particular gaming parameters or statistics is compared to the best players' performances in those areas with similar playstyle. At step 408 discrepancies between the performances of the specific player and the best players are determined based on the comparison of step 406. At step 410 areas where the specific player may need to improve are determined by identifying one or more statistics/traits that exhibit discrepancies greater than a threshold specified for that statistic/trait. In some embodiments, the threshold is determined by calculating averages and standard deviations of a particular metric among a certain number of players in one or more matches as described above.

Referring back to FIG. 2, at 210, recommendations determined at 208 are presented to the first player. The recommendations are presented to the user through one or more of the various methods. In an embodiments, the recommendations are presented verbally through an audio equipment configured within the computer system of the first player, or as a peripheral to the computer system. In an alternative embodiment, the verbal recommendations are presented through an audio system that is connected to the server and the computer system of the first player, through a network. In some embodiments, a natural language generation engine such as Wordsmith (which presents the recommendations in a textual format) is used to deliver the recommendations. In other embodiments, engines such as Amazon Polly may be used to deliver the recommendations through a voice assistant like Amazon Alexa, Siri, or Google Assistant. Embodiments of the present specification may be incorporated in to an application, for example an Alexa skill, that is able to receive game data/recommendations and communicate those to the first player. The first player may send a verbal query to such a system as Alexa, for example, asking after a game “how can I get better at Call of Duty?” or “why am I dying so much on the level I just played?” or “what the best strategy for me in this mode?”. The system may thereby respond to the first player with the suitable recommendations. The voice-assisted recommendations act like a virtual coach that can process and respond in real-time.

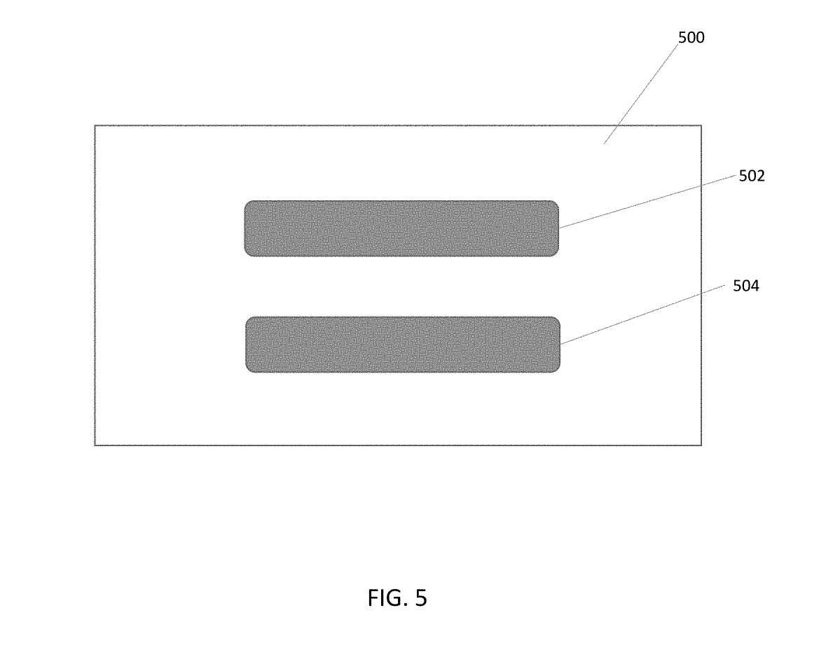

FIG. 5 illustrates an exemplary interface providing recommendations for improvement in one or more areas of a specific game, in response to a request by a player, in accordance with an embodiment of the present specification. In an embodiment, the interface is a display screen 500 comprising a request region 502, wherein a player may enter a query seeking a recommendation. In an embodiment, a freeform recommendation request, such as “How did I do in the last match?”, “How do I improve my skills?”, “What strategy should I use?”, “What role should I play?”. “What division should I use?”, or “Why did I lose?”, among other questions, may be entered by the player. In such a case, the player inputs the recommendation requests through an input device, such as a game controller, touch screen, mouse, keyboard, mobile phone, trackpad, wireless device, or other device. In another embodiment, request region 502 may display a series of predefined inquiries, such as “How did I do in the last match?”, “How do I improve my skills?”, “What strategy should I use?”, “What role should I play?”. “What division should I use?”, or “Why did I lose?”, among other questions. In such a case, the player selects one of the recommendation requests through an input device, such as a game controller, keyboard, mobile phone, touch screen, mouse, trackpad, wireless device, or other device. In another embodiment, the player may verbally query an engine, such as Alexa, a recommendation request. The engine recognizes the request and displays the request in the request region 502. Screen 500 further comprises a recommendation region 504, wherein a recommendation in response to the player's request is displayed in the form of areas where the specific player may need to improve.

In alternative embodiments, the recommendations are presented in the form of an in-game coach, like a drill-sergeant character or a coach in a sports game, or even as an Augmented Reality (AR) projection of such a character.

Other implementations, uses and advantages of the invention will be apparent to those skilled in the art from consideration of the specification and practice of the invention disclosed herein. The specification should be considered exemplary only, and the scope of the invention is accordingly intended to be limited only by the following claims.

We claim:

1. A computer implemented method of making recommendations to a player for improving gaming skills during a gameplay session, the method being implemented in a host computer having one or more physical processors programmed with computer program instructions that, when executed by the one or more physical processors, cause the host computer to perform the method, the method comprising:
determining, by the host computer, the player's playstyle based on at least one player metric, wherein the player is associated with first performance data and wherein the first performance data comprises the at least one player metric;
searching, by the host computer, for other players with similar playstyle, wherein the other players are associated with second performance data and wherein the second performance data comprises at least one average metric that is greater than the at least one player metric;
comparing, by the host computer, the second performance data with the first performance data;
determining, by the host computer, areas of improvement for the player based on the comparison; and
presenting, by the host computer, recommendations to the player on the basis of the determined areas of improvement.

2. The method of claim 1, wherein the at least one average metric is greater than the at least one player metric by at least one standard deviation.

3. The method of claim 1, wherein determining the player's playstyle comprises determining values for game statistics of the player based on the first performance data.

4. The method of claim 3, wherein values of the game statistics define one or more traits for a playstyle.

5. The method of claim 3, wherein determining the player's playstyle comprises determining the values for game statistics based upon at least one of a map of the game or a mode of the gameplay.

6. The method of claim 1, wherein determining the player's playstyle comprises obtaining the player's self-identification of the playstyle.

7. The method of claim 1, wherein searching for the other players is based on at least a type of the game or a mode of the game.

8. The method of claim 1, wherein comparing the second performance data with the first performance data comprises comparing set of predefined game parameter values obtained from the first performance data with a corresponding set of predefined game parameter values obtained from the second performance data.

9. The method of claim 1, wherein the determining of areas of improvement for the player is based on discrepancies between the second performance data and the first performance data.

10. The method of claim 1, further comprising computer program instructions that, when executed by the one or more physical processors, cause the host computer to infer one or more generic recommendations from the one or more recommendations presented to the first player.

11. A system of making recommendations to a player for improving gaming skills during a gameplay session, the system comprising:
a host computer comprising one or more physical processors programmed by computer program instructions that, when executed, cause the host computer to:
determine the player's playstyle based on at least one player metric, wherein the player is associated with first performance data and wherein the first performance data comprises the at least one player metric;
search for other players with similar playstyle, wherein the other players are associated with second performance data and wherein the second performance data comprises at least one average metric that is greater than the at least one player metric;
compare the second performance data with the first performance data;
determine areas of improvement for the player based on the comparison; and
present recommendations to the player on the basis of the determined areas of improvement.

12. The system of claim 11 further comprising a virtual coaching application hosted and implemented at least partly by the host computer.

13. The system of claim 12 wherein the virtual coaching application comprises program instructions that, when executed, cause the host computer to processes one or more discrepancies between the second performance data and the first performance data and use the discrepancies to determine the areas of improvement for the player.

14. The system of claim 11 further comprising a database in communication with the host computer for storing at least the first performance data and the second performance data.

15. The system of claim 11 further comprising an audio output configured to present the recommendations to the player.

16. The system of claim 11, wherein the at least one average metric is greater than the at least one player metric by at least one standard deviation.

17. The system of claim 11, wherein the host computer comprises one or more physical processors programmed by computer program instructions that, when executed, cause the host computer to determine the player's playstyle by determining values for game statistics of the player based on the first performance data.

18. The system of claim 17, wherein values of the game statistics define one or more traits for a playstyle.

19. The system of claim 17, wherein the host computer comprises one or more physical processors programmed by computer program instructions that, when executed, cause the host computer to determine the player's playstyle by determining the values for game statistics based upon at least one of a map of the game or a mode of the gameplay.

20. The system of claim 11, the host computer comprises one or more physical processors programmed by computer program instructions that, when executed, cause the host computer to determine the player's playstyle by obtaining the player's self-identification of the playstyle.
